(19) United States
(12) Patent Application Publication
(10) Pub. No.: US 2025/0142008 A1
(43) Pub. Date: May 1, 2025

(54) IMAGE FORMING APPARATUS

(71) Applicant: BROTHER KOGYO KABUSHIKI KAISHA, Nagoya (JP)

(72) Inventors: Shuya ICHIKAWA, Nagoya (JP); Shota IRIYAMA, Toyokawa (JP)

(21) Appl. No.: 18/911,729

(22) Filed: Oct. 10, 2024

(30) Foreign Application Priority Data
Oct. 31, 2023 (JP) 2023-186361

(51) Int. Cl. H04N 1/00; G03G 15/00; G03G 15/20; G03G 21/16

(52) U.S. Cl. CPC H04N 1/00538; G03G 15/2064; G03G 15/502; G03G 15/5087; G03G 15/55; G03G 15/6529; G03G 21/1633; H04N 1/00037; H04N 1/00074; H04N 1/00082; H04N 1/00832; H04N 1/00917; H04N 2201/0094

(57) ABSTRACT

An image forming apparatus includes a fuser, a detection sensor, a user interface, a memory, and a controller. The fuser is configured to fix an image formed in toner on a sheet thereon. The fuser is attached to a body of the image forming apparatus and is replaceable. The controller is configured to update usage data stored in the memory according to usage of the fuser. After the detection sensor detects the fuser not being attached to the body of the image forming apparatus, in response to the detection sensor detecting the fuser being attached to the body, the controller is configured to control the user interface to display a query screen concerning replacement of the fuser. In response to a replying operation to the query screen by a user, the controller is configured to update the usage data with content concerning a replacing new fuser.

### REFERENCE TO RELATED APPLICATIONS

This application claims priority from Japanese Patent Application No. 2023-186361, filed on Oct. 31, 2023. The entire content of the priority application is incorporated herein by reference.

### BACKGROUND ART

An image forming apparatus that may print an image by forming the image in toner on a sheet being a printing medium and heating the sheet to fix the image thereon is known. Generally, the image forming apparatus may heat the sheet with a fuser, which may apply heat generated in an electrical heater. Meanwhile, as the image forming apparatus is used over time, imaging quality of the fuser may lower. Therefore, replacement of the fuser with a new one may be necessary after being used for a predetermined number of times.

### SUMMARY

Based on the necessity, an image forming apparatus with a removable fuser for replacement has been suggested. Meanwhile, improvement of convenience to a user who replaces the fuser with another has been desired.

The present disclosure relates to an image forming apparatus with a replaceable fuser where a user may replace the fuser conveniently.

According to an aspect of the present disclosure, an image forming apparatus includes a fuser, a detection sensor, a user interface, a memory, and a controller. The fuser is configured to fix an image formed in toner on a sheet thereon. The fuser is attached to a body of the image forming apparatus and is replaceable. The controller is configured to update usage data stored in the memory according to usage of the fuser, the usage data indicating a usage degree of the fuser; after the detection sensor detects the fuser not being attached to the body of the image forming apparatus, in response to the detection sensor detecting the fuser being attached to the body of the image forming apparatus, control the user interface to display a query screen concerning replacement of the fuser; and in response to a replying operation to the query screen by a user, update the usage data with content concerning a replacing new fuser, of which attachment to the body is being detected currently.

According to another aspect of the present disclosure, an image forming apparatus includes a fuser, a detection sensor, a user interface, a memory, and a controller. The fuser is configured to fix an image formed in toner on a sheet thereon. The fuser is attached to a body of the image forming apparatus and is replaceable. The controller is configured to update usage data stored in the memory according to usage of the fuser, the usage data indicating a usage degree of the fuser; after the detection sensor detects the fuser not being attached to the body of the image forming apparatus, in response to the detection sensor detecting the fuser being attached to the body of the image forming apparatus, control the user interface to display a query screen concerning replacement of the fuser; after receiving a replying operation to the query screen from a user, control the user interface to display a standby screen, the standby screen including an option to instruct the user interface to display an updating screen, the updating screen being operable for updating the usage data; in response to receiving an operation to select the option to instruct the user interface to display the updating screen through the standby screen, control the user interface to display the updating screen; and based on an operation by the user to the updating screen, update the usage data with content concerning a replacing new fuser, of which attachment to the body is being detected currently.

According to another aspect of the present disclosure, an image forming apparatus includes a fuser, a detection sensor, a user interface, a memory, and a controller. The fuser is configured to fix an image formed in toner on a sheet thereon. The fuser is attached to a body of the image forming apparatus and is replaceable. The controller is configured to update usage data stored in the memory according to usage of the fuser, the usage data indicating a usage degree of the fuser; in a case where a predetermined condition is satisfied, control the user interface to display a standby screen, the standby screen including an option to instruct the user interface to display an updating screen, the updating screen being operable for updating the usage data; in response to receiving an operation to select the option instructing the user interface to display the updating screen through the standby screen, control the user interface to display the updating screen; and based on an operation by the user to the updating screen, update the usage data with content concerning a replacing new fuser, of which attachment to the body is being detected currently.

### BRIEF DESCRIPTION OF DRAWINGS

FIG. 1 is an illustrative cross-sectional view of a printer.

FIG. 2 is a perspective view of the printer with a rear cover being open.

FIG. 3 is a perspective view of the printer with a fuser being detached.

FIG. 4 is a block diagram to illustrate an electric configuration of the printer.

FIG. 5 is a flowchart to illustrate a flow of steps in a main process to be executed in the printer.

FIG. 6 is an illustrative view of a standby screen to be displayed in a user interface (I/F).

FIG. 7 is a flowchart to illustrate a flow of steps in an after absence-detection process to be executed in the printer.

FIG. 8 is a flowchart to illustrate a flow of steps in an error-condition alerting process to be executed in the printer.

FIGS. 9A-9D are illustrative views of query screens to be displayed in the user I/F.

FIG. 10 is a flowchart to illustrate a flow of steps in a manual updating process to be executed in the printer.

FIGS. 11A-11C are illustrative views of updating screens to be displayed in the user I/F.

FIG. 12 is a flowchart to illustrate a flow of steps in a printing process to be executed in the printer.

### DESCRIPTION

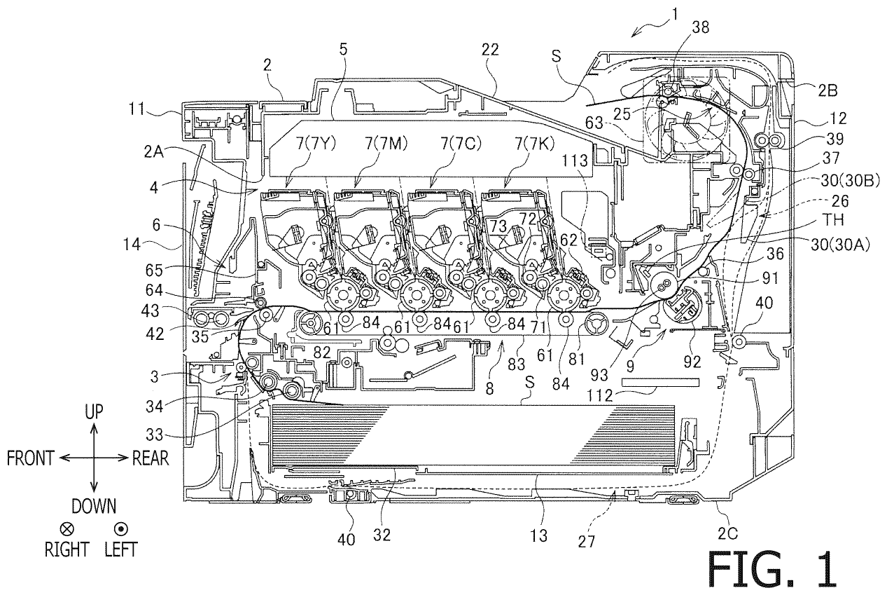

An embodiment of the present disclosure will be described below. FIG. 1 is an illustrative cross-sectional view of a printer 1 according to the embodiment of the present disclosure. In the description below, directions concerning the printer 1, such as front, rear, up, and down, are based on an orientation indicated by arrows in FIGS. 1-3.

### Overall Configuration of Printer

The printer according to the embodiment of the present disclosure is an electrophotographic color laser printer that may print images in multiple colors on a sheet S. Optionally, however, the printer 1 may be a monochrome laser printer. The printer 1 includes a main body 2, a conveyer 3, a process unit 4, and a fuser 9.

The main body 2 includes a front cover 11, a rear cover 12, a feeder tray 13, an ejection tray 22, and first-third conveyer paths 25-27. The front cover 11 may cover or expose a front opening 2A formed on a front side of the main body 2 and is attached to the front side of the main body 2 in an openable/closable structure. The rear cover 12 may cover or expose a rear opening 2B formed on a rear side of the main body 2 and is attached to the rear side of the main body 2 in an openable/closable structure. The feeder tray 13 is detachably attached to a lower side of the main body 2. The feeder tray 13 may be loaded with sheets S. The sheets S may be in a standard size such as, for example, A4 size. The sheets S may be, for example, paper medium including regular paper sheets and card boards, but may not necessarily be limited thereto, and may be, for another example, OHP films. The ejection tray 22 is located on an upper side of the main body 2, and the sheets S with images formed thereon are ejected thereat.

In the front cover 11, a multipurpose tray (manual-feed tray) 14 is formed. The multipurpose tray 14 may be tilted outward, and the sheets S may be fed from the multipurpose tray 14 to the printer 1 through the multipurpose tray 14. The printer 1 may print an image on the sheet S fed from either the feeder tray 13 or the multipurpose tray 14 selectively.

The conveyer 3 includes a pickup roller 33, a separation roller 34, a registration roller 35, a first conveyer roller 36, a second conveyer roller 37, a first switchback roller 38, a second switchback roller 39, a plurality of third conveyer rollers 40, a flapper 30, and a main motor 106. A part of the second conveyer path 26 is formed of the rear cover 12 in a closed position.

The pickup roller 33 may pick up the sheets S lifted upward by a sheet-lifting plate 32 from the feeder tray 13 and convey the sheets S toward the first conveyer path 25. The separation roller 34 may separate one of the sheets S picked up by the pickup roller 33 from the other.

The registration roller 35 is located upstream from the process unit 4 in a conveying direction to convey the sheet S in the first conveyer path 25. The registration roller 35 may correct a direction of a frontward edge of the sheet S and convey the sheet S toward the process unit 4. The registration roller 35 conveys the sheet S from the front side toward the rear side, i.e., rearward.

The conveyer 3 may, for conveying the sheet S outside the main body 2, when the rear cover 12 is closed, convey the sheet S from the process unit 4 by operating the first conveyer roller 36 and guide the sheet S to the first conveyer path 25 by operating the flapper 30 (30A). Further, the conveyer 3 may convey the sheet S guided through the first conveyer path 25 by operating the second conveyer roller 37 and the first switchback roller 38 and eject the sheet S outside at the ejection tray 22.

On the other hand, when the rear cover 12 is open, the conveyer 3 may, for conveying the sheet S outside the main body 2, convey the sheet S from the process unit 4 by operating the first conveyer roller 36, guide the sheet S rearward in conjunction with the flapper 30 (30B) pivoted to a position indicated in virtual lines, and eject the sheet S through the rear opening 2B to rest on the rear cover 12 being in an open position. The printer 1 may form an image on the sheet S both when the rear cover 12 is closed and open. The rear cover 12, when in the open position, allows the sheet S with the image formed thereon to be ejected through the rear opening 2B.

Moreover, the conveyer 3 may, for conveying the sheet S to reenter the process unit 4, convey the sheet S once exited the process unit 4 by operating the first conveyer roller 36 and guide the sheet S to the first conveyer path 25 or the second conveyer path 26 the flapper 30. If the sheet S is guided to the first conveyer path 25, the conveyer 3 may convey the sheet S in the first conveyer path 25 to the third conveyer path 27 with the second conveyer roller 37 and the first switchback roller 38. On the other hand, if the sheet S is guided to the second conveyer path 26, the conveyer 3 may convey the sheet S in the second conveyer path 26 to the third conveyer path 27 by operating the second switchback roller 39.

The sheet S conveyed to the third conveyer path 27 may be fed once again to the process unit 4 by the third conveyer rollers 40 and the registration roller 35, etc., and an image may be formed on the sheet S by the process unit 4. Thereafter, the sheet S with the image formed thereon may be ejected by the conveyer 3 at the ejection tray 22.

The conveyer 3 further includes a separation pad 42 and a pickup feed roller 43 for separating the sheet S from the other sheets S inserted manually from the multipurpose tray 14 and conveying the separated sheet S. The separation pad 42 and the pickup feed roller 43 may separate one of the sheets S inserted from the multipurpose tray 14 from the other and convey the separated sheet S toward the process unit 4. The flow to convey the sheet S fed from the multipurpose tray 14 onward is the same as that described above to convey the sheet S fed from the feeder tray 13. In the description below, the separation pad 42 and the pickup feed roller 43 provided in the multipurpose tray 14 may be collectively called “PF kit MP” where PF stands for paper-feed. The PF kit MP is one of consumable items in the printer 1 that may be replaced with a new one by a user. The consumable items include a fuser 9 and a conveyer belt 83 described below. The PF kit MP and the conveyer belt 83 form a sheet conveyer.

The process unit 4 has a function to form images on a sheet S and may transfer toner images onto the sheet S. The process unit 4 includes an exposure device 5, a drum unit 6, and four developing cartridges 7Y, 7M, 7C, 7K, and a transfer unit 8.

The exposure device 5 is located at an upper position in the main body 2 and includes a light source, polygon mirrors, lenses, and reflection mirrors, which are not shown. The exposure device 5 may emit light beams, as indicated in dash-and-dot lines, at surfaces of photosensitive drums 61 and irradiate the surfaces of the photosensitive drums 61.

The drum unit 6 is located in the main body 2 between the feeder tray 31 and the exposure device 5 and includes four photosensitive drums 61, four chargers 62, a pinch roller 64, and a supporting frame 65 which supports the photosensitive drums 61 and other devices. The drum unit 6 is, when the front cover 11 is open, attachable to and detachable from the main body 2 through the front opening 2A. The pinch roller 64 may rotate in accordance with rotation of the registration roller 35 and may convey the sheet S in conjunction with the registration roller 35.

The developing cartridges 7Y, 7M, 7C, 7K correspond to colors of yellow (Y), magenta (M), cyan (C) and black (K), respectively and are detachably attached to the drum unit 6 in the given order from the front side toward the rear side. The developing cartridges 7Y, 7M, 7C, 7K each include a developing roller 71, a supplying roller 72, and a toner container 73. The developing cartridges 7Y, 7M, 7C, 7K may only be different from one another in the colors of toners contained therein but are generally the same in the configurations thereof. Therefore, in the description below, the developing cartridges 7Y, 7M, 7C, 7K may be representatively expressed as a developing cartridge 7, which may be any one of the developing cartridges 7Y, 7M, 7C, 7K.

The transfer unit 8 is located in the main body 2 between the feeder tray 31 and the drum unit 6 and includes a driving roller 81, a driven roller 82, the conveyer belt 83, and four transfer rollers 84. The conveyer belt 83 is strained around the driving roller 81 and the driven roller 82, and an upper outer surface of the conveyer belt 83 is in contact with the photosensitive drums 61. The four transfer rollers 84 are located on an inner side of the conveyer belt 83 and nip the conveyer belt 83 together with the photosensitive drums 61.

The fuser 9 is located in the main body 2 rearward from the process unit 4. In particular, the fuser 9 is located between the rear cover 12 in the closed posture and the process unit 4. The fuser 9 includes a heat roller 91 to heat the sheet S and a pressure applier 92 to nip the sheet S together with the heat roller 91. According to the present embodiment, the heat roller 91 includes a heater 93 for heating the heat roller 91. The pressure applier 92 includes an endless belt, a pressure pad to nip the endless belt together with the heat roller 91, a holder supporting the pressure pad, and a belt guide, which are shown but not signed in the drawings.

The process unit 4 may charge the surfaces of the photosensitive drums 61 evenly with the chargers 62 by irradiating the surfaces of the photosensitive drums 61, and thereby electrostatic latent images are formed on the surfaces of the photosensitive drums 61. Moreover, the process unit 4 may supply the toners from the toner containers 73 to the supplying rollers 72, and from the supplying rollers 72 to the developing rollers 71. The toners supplied to the developing rollers 71 are carried on the developing rollers 71 while the developing rollers 71 rotate.

The process unit 4 may form toner images on the surfaces of the photosensitive drums 61 by supplying the toners carried on the developing rollers 71 to the electrostatic latent images formed on the photosensitive drums 61. Further, the process unit 4 may convey the sheet S fed from the feeder tray 13 by the conveyer 3 through the positions between the photosensitive drums 61 and the conveyer belt 83 to transfer the toner images from the photosensitive drums 61 to the sheet S. Thereafter, the process unit 4 may convey the sheet S to the fuser 9.

The fuser 9 may fix the toner images transferred from the photosensitive drums 61 onto the sheet S by conveying the sheet S through a position between the heat roller 91 and the pressure applier 92, and thereby the image is formed on the sheet S.

The printer 1 further includes a fuser fan 63 and a fuser-temperature sensor TH inside the main body 2.

The fuser fan 63 may, when activated, vent the air inside the main body 2 outward.

The fuser-temperature sensor TH is a temperature sensor and may output signals according to the temperature of the fuser 9, or more specifically, temperature of the heat roller 91. The fuser-temperature sensor TH is located inside the fuser 9 at a position to face, without contacting, the heat roller 91. The fuser-temperature sensor TH includes, for example, a contactless-typed thermistor.

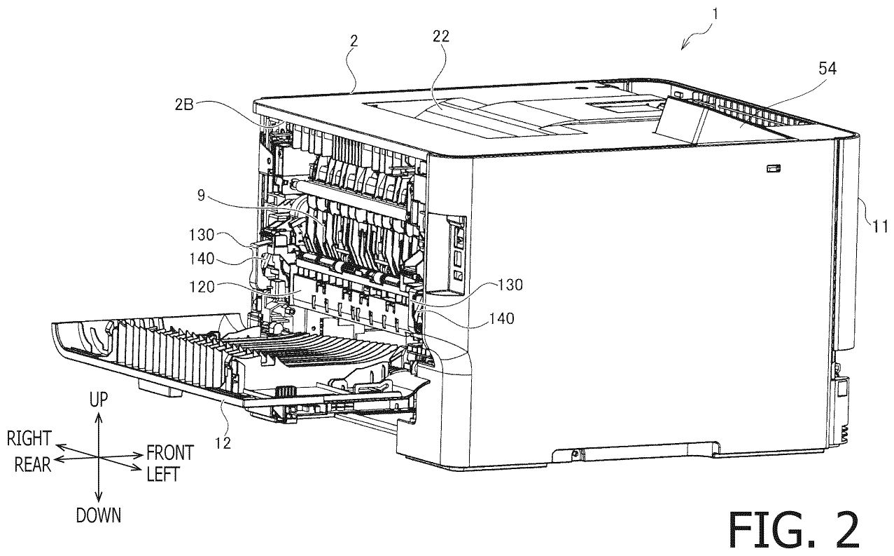

The fuser 9 is detachable from and attachable to the main body 2 through the rear opening 2B, which is formed in the main body 2 and is exposed by opening the rear cover 12. FIG. 2 illustrates the printer 1 with the rear cover 12 being open. As shown in FIG. 2, the fuser 9 includes a fuser body 120, lock handles 130, and levers 140. The lock handle 130 is provided on a rightward end and a leftward end of the fuser body 120, and each of the lock handles 130 is provided with the lever 140.

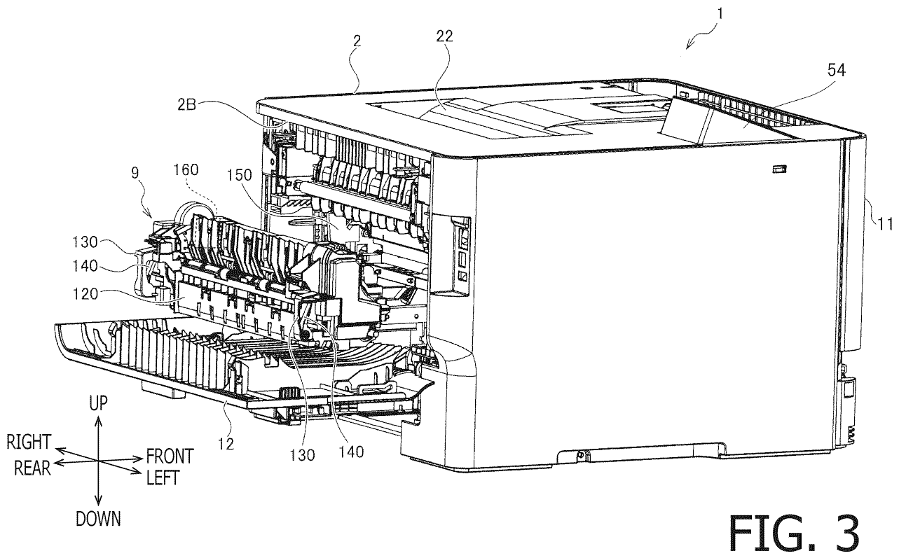

A user may grab the levers 140 and pull the lock handles 130 rearward, and thereby, as shown in FIG. 3, the fuser 9 may be detached from the main body 2. At the same time, a fuser connector 160 provided to the fuser 9 may separate from a body connector 150 provided to the main body 2. In other words, the fuser connector 160 and the body connector 150 are connected to each other when the fuser 9 is attached to the main body 2 and are separated from each other when the fuser 9 is detached from the main body 2.

On a triangular portion raised from an upper surface of the main body 2, a user interface (I/F) 54 is arranged. The user I/F 54 may provide information to the user, and operations by the user may be input through the user I/F. In particular, the user I/F 54 may be arranged in an inclined posture with respect to the triangular portion so that the user standing on the front side of the printer 1 may view the user I/F 54 easily. The user I/F 54 may be a touch panel having a displaying function.

### Electrical Configuration of Printer

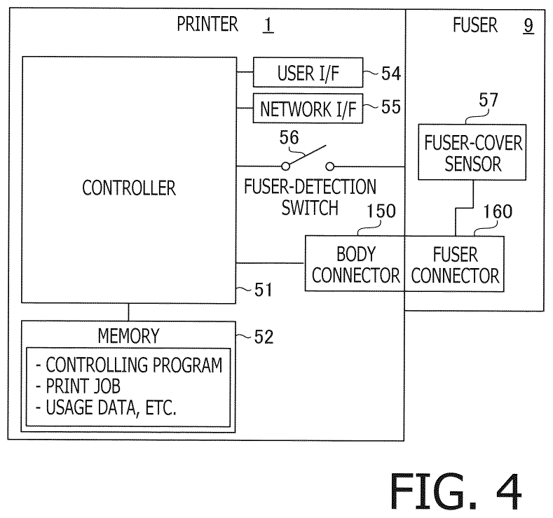

FIG. 4 illustrates an electrical configuration of the printer 1. The printer 1 includes a controller 51, a memory 52, the user I/F 54, a network I/F (communication I/F) 55, a fuser-detection switch 56, and the body connector 150. The fuser 9 is detachable from and attachable to the printer 1 and includes a fuser-cover sensor 57 and the fuser connector 160. These electrical components are connected through a bus and may communicate with one another.

The controller 51 includes a CPU and Application Specific Integrated Circuit (ASIC). The memory 52 is an embedded memory and may be a combination of ROM, RAM, NVRAM, SSD, and/or HDD. The ROM, RAM, NVRAM included in the controller 51 usable for executing programs may be regarded a part of the memory 52.

The memory 52 is an example of the computer-readable storage medium storing information readable by the controller 51. The storage medium storing information readable by the controller 51 is a non-transitory medium, which is a tangible medium. Meanwhile, electrical signals conveying a program downloadable through the Internet, for example, from a server, may form a computer-readable signal medium but may not form a non-transitory computer-readable storage medium.

The memory 52 stores programs executable by the controller 51. In the following paragraphs, processes to be executed by the controller 51 in compliance with instructions described in the programs stored in the memory 52 will be explained. In the explanation, terms to express acts in the printer 1 such as judging, selecting, calculating, determining, specifying, obtaining, receiving, and controlling may represent processes executed by the controller 51. Meanwhile, an act of obtaining may not necessarily be induced by an act of requesting. In other words, the controller 51 may receive data without requesting, and the act of receiving may still be expressed as “the controller 51 obtains the data.” Moreover, a term “data” in the present disclosure may mean a bit string readable by a computer. Data units containing substantially the same contents but in different formats may be regarded as a same data unit, and a term “information” may be regarded similarly.

Moreover, the memory 52 may store print job(s) currently in queue and usage data concerning consumable items. The consumable items, of which usage data is recorded, may include, for example, the fuser 9, the conveyer belt 83, the PF kit MP (the kit including the separation pad 42 and the pickup feed roller 43). The usage data may indicate, for example, usage degrees, which are degrees of usage of the consumable items. For example, the usage data may indicate a number of printed sheets S counting from previous replacement of the consumable item to the present time (with regard to the PF kit MP, a number of printed sheets S from the multipurpose tray 14), a percentage of a number of sheets S that may be printed further with respect to a recommended number of sheets S to be reached for replacing the consumable item. For another example, in place of the number of printed sheets S, the usage data may be represented in lengths of time in which the consumable items are used. In the present embodiment, after the consumable item is replaced with a new one, the usage data stored in the memory 52 is reset to, or updated with, data corresponding to the replacing new consumable item.

The user I/F 54 includes a touch panel, which also functions as a display, and intervenes between the user who operates the printer 1 and the controller 51. The user I/F 54 may provide information of various types to the user and receive instructions from the user to operate the printer 1. A surface of the user I/F 54 is formed of a liquid crystal display that may display dialogue screens including, for example, “query screen,” “standby screen,” and “updated screen,” which will be described later in detail. As such, the user I/F 54 may teach the usage degrees of the consumable items to the user and guide the user to reset the percentage of the number of sheets S to be printed further with respect to the recommended number for replacement of the consumable item, such as the fuser 9, after the replacement of the consumable item, based on the usage data stored in the memory 52. Moreover, the user I/F 54 may display optional items, buttons, icons, and objects on the liquid crystal display to the user, and the user may select one or more of the options through the liquid crystal display. The user interface to receive the user's selections may not necessarily be limited to the touch panel but may include physical keys. In other words, the user interface may be formed of the liquid display and physical keys.

In the present embodiment, the items that may be operated or selected by the user or an administrator who uses or administrates the printer 1 may be called by terms “options,” “buttons,” “icons,” or “objects,” etc. for convenience, but the terms may not necessarily be limited but may be replaced with others.

The network I/F 55 connects the printer 1 to a network through a wire or wirelessly. For example, the printer 1 may receive a print command, including image data that composes an image to be printed, transmitted from a terminal device, such as PC, connected to the same network, through the network I/F 55, and print the image on the sheet S in accordance with the received print command.

The fuser-detection switch 56 is a sensor to detect whether the fuser 9 is attached to or detached from the printer 1. The fuser-detection switch 56 may include, for example, a physical switch and may be located at a position corresponding to the fuser 9 being attached to the printer 1. When the fuser 9 is attached to the printer 1, the fuser-detection switch 56 is pushed by the fuser 9 and is turned on (attachment detected). On the other hand, when the fuser 9 is not attached to the printer 1, the fuser-detection switch 56 is released from the pressure of the fuser 9 and is turned off (absence detected). The sensor to detect attachment of the fuser 9 may not necessarily be limited to a physical switch but may include, for example, a contactless-typed sensor such as a proximity sensor.

On the other hand, the fuser-cover sensor 57 is a sensor to detect an open or closed state of a fuser-unit cover provided to the fuser 9. The fuser-cover sensor 57 may be a physical switch, similarly to the fuser-detection switch 56, or may be a contactless-typed sensor such as a proximity sensor.

The body connector 150 is formed of a positioning pin and a socket having a plurality of contacts, which are not shown, aligned vertically. On the other hand, the fuser connector 160 is formed of a recess, in which the positioning pin is inserted, and a plug having a plurality of contacts that come into contact with the contact on the body connector 150. By locating the fuser connector 160 and the body connector 150 to fit with each other, the printer 1 and the fuser 9 are connected physically and electrically, and the fuser 9 is in the condition attached to the printer 1.

### Controlling Process by the Controller

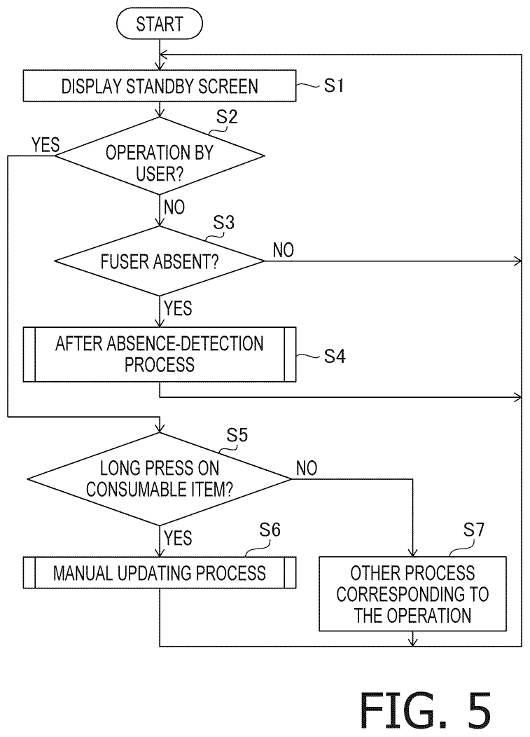

Next, among various controlling processes to be executed by the controller 51 in the printer 1, a controlling process to be executed in relation to replacement of one of the consumable items, e.g., the fuser 9, will be described with reference to FIG. 5. FIG. 5 is a flowchart to illustrate a flow of steps in a main process to be executed by the controller 51 in the printer 1. The main process is executed shortly after the printer 1 is powered on. Specifically, FIG. 5 is a flowchart to illustrate a part of the main process related to updating of the usage data concerning the consumable item stored in the memory 52. The flows of steps in flowcharts in processes shown in FIGS. 5, 7, 8, 10, and 12 are stored in the memory 52 in the printer 1 and executed by the controller 51.

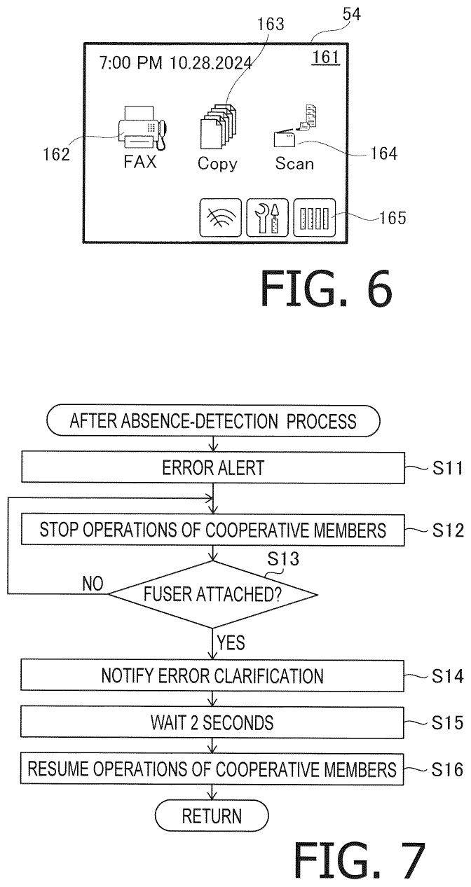

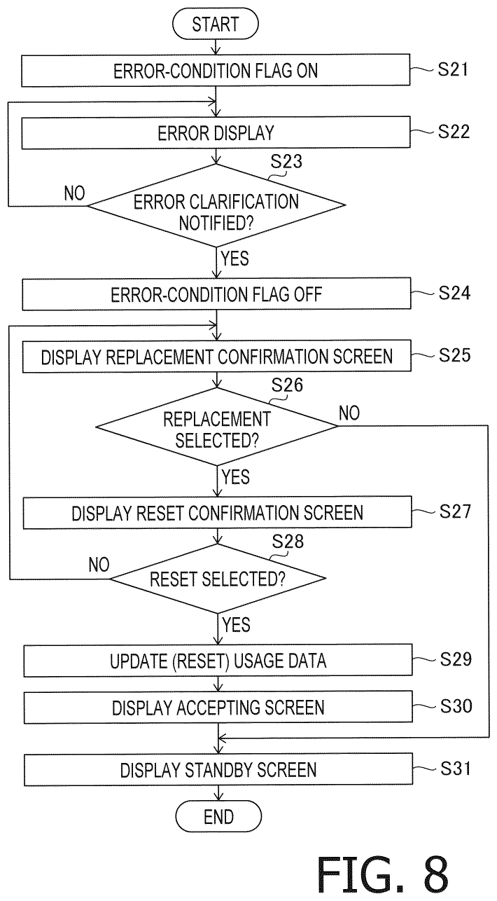

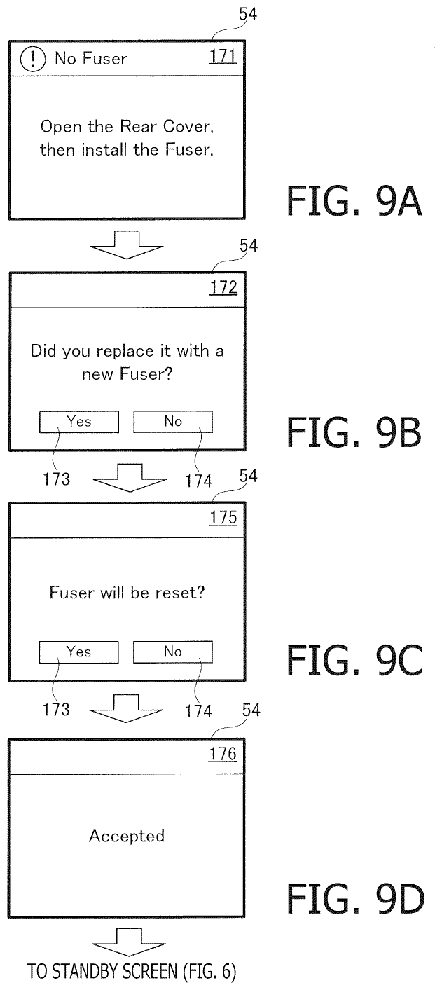

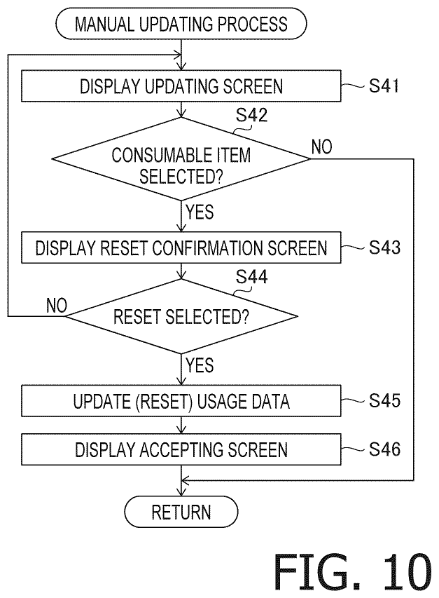

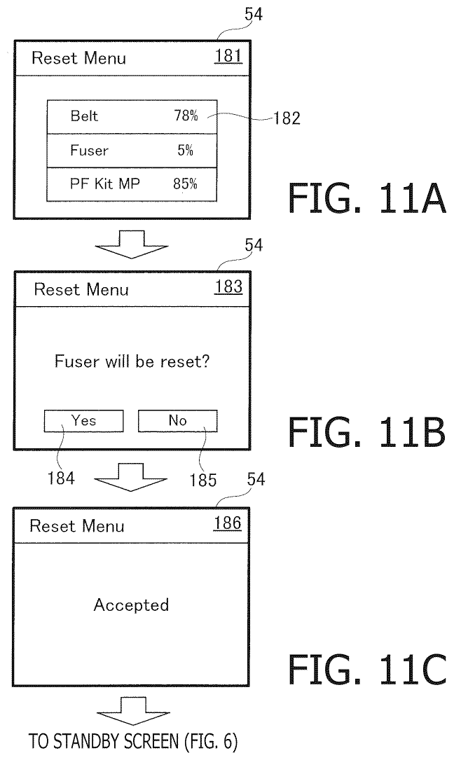

In S1, the controller 51 executes a predetermined startup process in response to powering on and thereafter controls the user I/F 54 to display a standby screen. For example, the controller 51 may control the user I/F 54 to display a standby screen 161 as shown in FIG. 6. As shown in FIG. 6, the standby screen 161 displays icons, which may be operated selectively by the user to command the printer 1 to execute one of the functions of the printer 1, in a middle area. For example, the standby screen 161 may display an icon 162 operated for using the facsimile communication function, an icon 163 operated for using the copier function, an icon 164 operated for using the scanner function. Moreover, a consumable-item icon 165, which may be operated by the user for updating the usage data for the consumable items, is displayed in an area below the icons 162-164. The consumable-item icon 165 may also serve as an icon to cause the user I/F 54 to display remaining amounts of the consumable items, e.g., remaining amounts of the toners. As described above, the user I/F 54 is a touch panel having the function of the display; therefore, the user may touch a desired one of the icons displayed in the standby screen 161 to select one of the options.

Next, in S2, the controller 51 determines whether the user operated the user I/F 54 to select any one of the icons displayed in the standby screen 161 based on operation signals input from the user I/F 54.

If the controller 51 determines that the user operated the user I/F 54 to select one of the icons in the standby screen 161 (S2: YES), the controller 51 proceeds to S5. On the other hand, if the controller 51 determines that the user did not operate the user I/F 54 to select any one of the icons in the standby screen 161 (S2: NO), the controller 51 proceeds to S3.

In S3, based on the detection signals from the fuser-detection switch 56, the controller determines whether the fuser 9 is not attached to the printer 1, in other words, absent.

If the controller 51 determines that the fuser 9 is absent (S3: YES), the controller 51 proceeds to S4. In S4, the controller 51 executes an after absence-detection process (see FIG. 7), which will be described further below.

If the controller 51 determines that the fuser 9 is not absent but is attached to the printer 1 (S3: NO), the controller 51 controls the user I/F 54 to continuously display the standby screen (S1).

On the other hand, if the controller 51 determines that the user operated the user I/F 54 to select any of the icons in the standby screen 161 (S2: YES), in S5, the controller 51 determines whether the user touched and held down the touch, in other words, performed long press, on the consumable-item icon 165.

If the controller 51 determines that the user performed long press on the consumable-item icon 165 (S5: YES), the controller 51 proceeds to S6. In S6, the controller 51 executes a manual updating process as shown in FIG. 10, which will be described further below.

On the other hand, if the controller 51 determines that the user operated the user I/F 54 by an action other than long press (S5: NO), the controller 51 executes a process corresponding to the action (S7). For example, if the user operates the user I/F 54 to select the icon 162, the controller 51 controls the user I/F 54 to display a screen to guide the user to use the facsimile transmission function, and the user may operate the printer 1 as guided. The printer 1 may thereafter scan an image provided by the user, generate image data based on the scanned image, and transmit the image data to a designated address.

Next, the after absence-detection process to be executed in S4 mentioned above will be described with reference to FIG. 7. FIG. 7 is a flowchart to illustrate a flow of steps in the after absence-detection process to be executed by the controller 51 in the printer 1.

First, in S11, the controller 51 alerts the user to an error condition that the fuser 9 is not attached to the printer 1. Along with the alert of the error condition, the controller 51 conducts an error-condition alerting process (see FIG. 8) in parallel to the after absence-detection process.

Next, in S12, the controller 51 stops operating cooperative members that are operable for printing an image on a sheet S in conjunction with the fuser 9. The cooperative members to be stopped operating in S12 include, for example, the rollers for conveying the sheet S, including the first conveyer roller 36 and the second conveyer roller 37, and more specifically, a motor to drive these rollers, and the heater to heat the heat roller 91. Moreover, it is preferable that the controller 51 stops operating the members that are located at positions reachable or touchable to the user when the user attempts to replace the fuser 9, e.g., the members appearing inside the main body 2 when the rear cover 12 is open. In this context, the expression “stop operating” may mean shutting the power to the cooperative members off, or, if the cooperative member has a structure to switch the power on or off, switching off the cooperative members while the power supply is continued. In other words, the process to stop operating the cooperative members that are operable for printing an image on a sheet S in conjunction with the fuser 9 in S12 is to ensure safety of the user who replaces the fuser 9.

After S12, in S13, the controller 51 determines whether the condition, in which the fuser 9 is absent from the printer 1, shifted to the condition, in which the fuser 9 is attached to the printer 1.

If the controller 51 determines that the fuser 9 is attached to the printer 1 (S13: YES), the controller 51 proceeds to S14. On the other hand, if the controller 51 determines that the fuser 9 continues to be absent from the printer 1 (S13: NO), the controller 51 maintains the state, in which the operations of the members that are operable for printing an image on a sheet S in conjunction with the fuser 9 are stopped.

In S14, in response to attachment of the fuser 9 to the printer 1, the controller 51 notifies the user of that the error condition is cleared. Meanwhile, in response to the notification that the error condition is cleared, in an error-condition alerting process (see FIG. 8), which will be described further below, the controller 51 determines that the error condition is cleared (S23: YES) and, in S25, controls the user I/F 54 to display a replacement confirmation screen 172 as shown in FIG. 9B.

In S15, the controller 51 stands by until a predetermined length of time, e.g., 2 seconds, elapses since the controller 51 detected the fuser 9 being attached. The predetermine length of time to stand by is provided for the user who attached the fuser 9 to the printer 1 to withdraw his/her hand from the fuser 9 and the surrounding components. In this regard, the replacement confirmation screen 172 as mentioned above and shown in FIG. 9B may guide the user to withdraw his/her hand from the fuser 9 and move the hand to the vicinity of the user I/F 54.

Next, in S16, the controller 51 resumes the operations of the cooperative members having been stopped since S12. In particular, the controller 51 executes a startup process with the cooperative members having been stopped and shifts the cooperative members to enter a standby state. Thereafter, the controller 51 returns to S1.

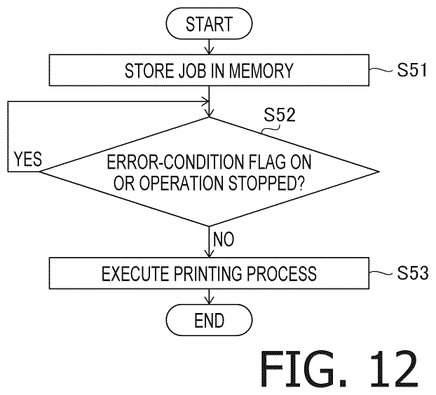

Meanwhile, during the after absence-detection process, in a period between the time when the operations of the cooperative members are stopped in S12 and the time when the operations are resumed in S16, the printer 1 is suspended from printing an image. During the period, however, the printer 1 may receive image data continuously or uninterruptedly through the network I/F 55 from a terminal device, e.g., PC, connected to the same network, or receive facsimile transmission through a telephone network. The controller 51 stores the image data or the facsimile data received during this period in the memory 52 and prints an image based on the stored image data once the operations of the cooperative members are resumed in S16 (see FIG. 12).

Moreover, while the operations of the cooperative members are stopped between S12 and S16, the copier function of the printer 1 may be used. In such an occasion, the printer 1 may continuously or uninterruptedly read an image appearing on a sheet to be copied and generate image data composing the read image even while the operation of the cooperative members are stopped. The controller 51 stores the image data generated during this period in the memory 52 and prints a copied image on the sheet S once the operations of the cooperative members are resumed in S16.

Next, the error-condition alerting process to be executed in parallel to the after absence-detection process (see FIG. 7) will be described with reference to FIG. 8. FIG. 8 is a flowchart to illustrate a flow of steps in the error-condition alerting process to be executed by the controller 51 in the printer 1. The error-condition alerting process starts in response to the alert of the error condition in S11 in the after absence-detection process (see FIG. 7) described above and is executed in parallel to the after absence-detection process.

First, in S21, the controller 51 sets an error-condition flag on, which indicates that the fuser 9 is absent from the printer 1. The error-condition flag may be stored in, for example, the memory 52 and is initially set off, which indicates that the fuser 9 is attached to the printer 1.

Next, in S22, the controller 51 controls the user I/F 54 to display an error screen. For example, the controller 51 may control the user I/F 54 to display an error screen 171 as shown in FIG. 9A. The error screen 171 alerts the user that the fuser 9 is not attached to the printer 1 and guides the user to open the rear cover 12 and attach the fuser 9 to the printer 1.

Next, in S23, the controller 51 determines whether the user is notified of the error condition being cleared. In this context, when the fuser 9 is attached to the printer 1 (S13: YES), the user is notified of clearing of the error condition in S14 in the after absence-detection process (see FIG. 7).

If the controller 51 determines that the user is notified of the error condition being cleared (S23: YES), the controller 51 proceeds to S24. On the other hand, if the controller 51 determines that the user is not notified of the error condition being cleared (S23: NO), the controller 51 controls the user I/F 54 to continuously display the error screen.

In S24, the controller 51 sets the error-condition flag, which indicates whether the fuser 9 is absent from the printer, off. The error-condition flag set off indicates that the fuser 9 is attached to the printer 1.

In S25, the controller 51 controls the user I/F 54 to display the replacement confirmation screen. For example, the controller 51 may control the user I/F 54 to display a replacement confirmation screen 172 as shown in FIG. 9B. As shown in FIG. 9B, the replacement confirmation screen 172 guides the user to confirm that the fuser 9 is replaced with a new fuser 9. In other words, while the controller 51 may detect the fuser 9 being attached thereto through the fuser-detection switch 56, the controller 51 may not recognize whether the replacing fuser 9 is an unused new fuser 9. For example, there may be a case that the fuser 9 used in the past has been removed for a while and may be attached once again to the printer 1. Therefore, through the replacement confirmation screen 172, the controller 51 directs the user to confirm newness of the currently attached fuser 9. Moreover, the replacement confirmation screen 172 includes options of YES icon 173 and NO icon 174, and the user may select one of the options. The YES icon 173 is the option to express that the fuser 9 is replaced with an unused fuser 9.

In S26, the controller 51 determines whether the user replied that the fuser 9 is replaced with an unused fuser 9, in other words, whether the user selected the YES icon 173 through the replacement confirmation screen 172.

If the controller 51 determines that the user replied that the fuser 9 has been replaced with an unused fuser 9, in other words, the user selected the YES icon 173, through the replacement confirmation screen 172 (S26: YES), the controller 51 proceeds to S27. On the other hand, if the controller 51 determines that the user did not reply that the fuser 9 has been replaced with an unused fuser 9, in other words, the user selected the NO icon 174, through the replacement confirmation screen 172 (S26: NO), the controller 51 proceeds to S31. The operation by the user to select the YES icon 173 corresponds to the operation to satisfy a condition to update the usage data, more specifically, an operation for expressing that the fuser has been replaced with another. The operation to select the NO icon 174 corresponds to the operation not satisfying the condition to update the usage data, more specifically, the operation for expressing that the fuser has not been replaced.

In S27, in response to the replacement of the fuser 9 with the unused fuser 9, the controller 51 controls the user I/F 54 to display a reset confirmation screen. For example, the controller 51 may control the user I/F 54 to display a reset confirmation screen 175 as shown in FIG. 9C. The reset confirmation screen 175 guides, in accordance with the replacement of the fuser 9, the user to confirm that the usage data concerning the fuser 9 stored in the memory 52 should be updated, i.e., reset, to content corresponding to the replacing new fuser 9. The usage data indicates how much the consumable items are used and may be represented by, for example, a number of printed sheets S counting from previous replacement of the consumable item until the present time, a percentage of the number of sheets S to be printed further with respect to a recommended number to be reached for replacement of the consumable item. For another example, rather than the number of printed sheets S, the usage data may be represented in lengths of time in which the consumable items are used. In the present embodiment, after the consumable item is replaced with a new one, the usage data stored in the memory 52 is updated with, or reset to, data corresponding to the new consumable item. The reset confirmation screen 175 includes options of the YES icon 173 and the NO icon 174, and the user may select one of the options. The YES icon 173 is the option to instruct that the usage data concerning the fuser 9 stored in the memory 52 should be updated in accordance with the replacement of the fuser 9.

If the controller 51 determines that the user confirmed resetting of the usage data concerning the fuser 9 through the reset confirmation screen 175, in other words, if the controller 51 determines that the user selected the YES icon 173 (S28: YES), the controller 51 proceeds to S29. On the other hand, if the controller 51 determines that the user did not confirm resetting of the usage data concerning the fuser 9 through the reset confirmation screen 175, in other words, if the controller 51 determines that the user selected the NO icon 174 (S28: NO), the controller 51 returns to S25 and controls the user I/F 54 to display the replacement confirmation screen 172 (see FIG. 9B). Optionally, if the controller 51 determines that the user selected the NO icon 174 (S28: NO), the controller 512 may control the user I/F 54 to display the standby screen 161 (S31) rather than displaying the replacement confirmation screen 172. The operation by the user to select the YES icon 173 in the reset confirmation screen 175 corresponds to the operation to satisfy the condition to update the usage data, as well as the operation to select the YES icon 173 in the replacement confirmation screen 172 explained above. The operation to select the NO icon 174 corresponds to the operation not satisfying the condition to update the usage data, as well as the operation to select the NO icon 174 in the replacement confirmation screen 172 explained above. If the user does not select resetting of the usage data at this point, the user may manually reset the usage data later at preferable timing through an updating screen, which may be reached from the standby screen (see FIGS. 10 and 11).

In the present disclosure, the replacement confirmation screen 172 and the reset confirmation screen 175 may be collectively called query screens. The replacement confirmation screen 172 is displayed immediately after notifying the user of clearing of the error condition; therefore, the period, in which the query screens are displayed (S25-S27), overlaps the period, in which the operations of the cooperative members are stopped, including the predetermined length of time since the notification of the clarification of the error condition, in the after absence-detection process (S12-S15 in FIG. 7), at least partly.

In S29, the controller 51 reads the usage data concerning the fuser 9 from the memory 52 and updates the usage data with data corresponding to the replacing unused fuser 9, in other words, resets the usage data. For example, if the number of printed sheets S from the time of the previous replacement to the present time is recorded as the usage data, the controller 51 clears the number of printed sheets S to zero. For another example, if the percentage of the number of sheets S to be printed further with respect to the recommended number for replacement of the consumable item is recorded as the usage data, the controller 51 sets the percentage to 100. In this context, 100% is the percentage when the number of sheets S having been printed is zero, whereas 0% is the percentage when the number of sheets S having been printed reaches the recommended number.

In S30, in accordance with the usage data being reset, the controller 51 controls the user I/F 54 to display an accepting screen. For example, the controller 51 may control the user I/F 54 to display an accepting screen 176 as shown in FIG. 9D. The accepting screen 176, as shown in FIG. 9D, informs the user that the usage data is reset. In other words, the manual updating process is a process, in which the user operates the printer 1 to update, or reset, the usage data manually when, for example, the user replaced the consumable item, e.g., the fuser 9, with a new one but did not update, or reset, the usage data concerning the consumable item for some reason at that time, or when the user replaced the consumable item with a new one while the printer 1 is powered off. Thereafter, the controller 51 proceeds to S31 and controls the user I/F 54 to display the standby screen 161.

The standby screen 161 to be displayed immediately after the error-condition informing process in FIG. 8 includes the consumable-item icon 165 mentioned earlier (see FIG. 6). The user may perform long press on the consumable-item icon 165 to start the manual updating process (see FIG. 10) described later. In the manual updating process, the usage data concerning the fuser 9 may be reset with the operation by the user. In other words, in the case where the user replaced the fuser 9 but did not select the YES icon 173 in the replacement confirmation screen 172 (S26: NO) or the reset confirmation screen 175 (S28: NO), the user may still reset the usage data concerning the fuser 9 by starting the manual updating process. Reasons why the user does not select the YES icon 173 in the replacement confirmation screen 172 (S26: NO) or the reset confirmation screen 175 (S28: NO) may include, for example, that the user selects the NO icon 174 by mistake, the power to the printer 1 is shut off before the user selects the YES icon 173, the printer 1 starts rebooting before the user selects the YES icon 173. For another example, it may be because a predetermined length of time elapsed while the replacement confirmation screen 172 or the reset confirmation screen 175 is being displayed, and the controller 51 controls the user I/F 54 to return to the standby screen 161. For another example, it may be because the controller 51 shifts the printer 1 to a so-called sleep mode while the replacement confirmation screen 172 or the reset confirmation screen 175 is being displayed, and by the time when the printer 1 wakes up from the sleep mode and shifts to the regular operating mode, the screen of the user I/F 54 may have returned to the standby screen 161. In the case where the fuser 9 is replaced with another while the printer 1 is powered off, the error-condition informing process as shown in FIG. 8 may not be executed. Therefore, in such cases, the user may reset the usage data concerning the fuser 9 after powering on the printer 1 by performing long press on the consumable-item icon 165 to start the manual updating process.

Next, the manual updating process to be executed in S6 (see FIG. 5) is described below with reference to FIG. 10. FIG. 10 is a flowchart to illustrate a flow of steps in the manual updating process to be executed by the controller 51 in the printer 1.

First, in S41, the controller 51 controls the user I/F 54 to display an updating screen. For example, the controller 51 may control the user I/F 54 to display an updating screen 181 as shown in FIG. 11A. Objects to be displayed in the updating screen 181 include, as shown in FIG. 11A, a list 182 of the consumable items used in the printer 1 and usage degrees of the consumable items. In FIG. 11A, three consumable items, i.e., the conveyer belt 83, the fuser 9, the PF kit MP including the separation pad 42 and the pickup feed roller 43 are listed as examples of the consumable items. Moreover, in the updating screen 181 shown in FIG. 11A, the usage degree is expressed by the percentage of the number of sheets S that may be printed further with respect to the percentage of the number of sheets S recommended for replacement, whereas 0% is the percentage when the number of sheets S to be printed reaches the recommended number. Optionally, the usage degree may be expressed in, for another example, a number of the sheets S having been printed so far after the previous replacement of the fuser 9. In the updating screen 181, the consumable items in the list 182 are presented as options, and the user may select one of the consumable items, of which usage data is to be updated, or reset, from the list 182.

In S42, the controller 51 determines whether the user selected one of the consumable items, of which usage data is to be updated, or reset, from the list 182 in the updating screen 181.

If the controller 51 determines that the user selected one of the consumable items, of which usage data is to be updated, or reset (S42: YES), the controller 51 proceeds to S43. On the other hand, if the controller 51 determines that the user did not select any of the consumable items, of which usage data is to be updated, or reset (S42: NO), the controller 51 controls the user I/F 54 to display the standby screen 161 in S1 (see FIG. 5).

In response to the user selecting one of the consumable items, of which usage data is to be updated, or reset (S42: YES), in S43, the controller 51 controls the user I/F 54 to display a reset confirmation screen. For example, the user I/F 54 may display a reset confirmation screen 183 as shown in FIG. 11B. The reset confirmation screen 183 guides the user to confirm updating, or resetting, of the usage data stored in the memory 52 concerning the consumable item selected by the user. FIG. 11B illustrates the case when the user selected the fuser 9 in the updating screen 181 shown in FIG. 11A. The usage data indicates the usage degree of the consumable item and may be represented in, for example, a number of the sheets S having been printed since the previous replacement of the consumable item, or a number of the sheets that may be printed further with respect to a recommended number of the sheets S to be printed for replacement of the consumable item. For another example, in place of the number of the sheets S to be printed, the usage data may be represented in a length of time in which the consumable item is used. The reset confirmation screen 183 includes options of a YES icon 184 and a NO icon 185, similarly to the reset confirmation screen 175, and the user may select one of the options.

If the controller 51 determines that the user confirmed resetting of the usage data concerning the fuser 9 through the reset confirmation screen 183, in other words, if the controller 51 determines that the user selected the YES icon 184 (S44: YES), the controller 51 proceeds to S45. On the other hand, if the controller 51 determines that the user did not confirm resetting of the usage data concerning the fuser 9 through the reset confirmation screen 183, in other words, if the controller 51 determines that the user selected the NO icon 185 (S44: NO), the controller 51 returns to S41 and controls the user I/F 54 to display the updating screen 181 once again. Optionally, if the controller 51 determines that the user selected the NO icon 85 (S44: NO), the controller 51 may control the user I/F 54 to display the standby screen 161 in S1 (see FIG. 5) rather than displaying the updating screen 181.

In S45, the controller 51 reads the usage data concerning the consumable item specified by the user from the memory 52 and updates the usage data with data corresponding to the replacing unused consumable item, in other words, resets the usage data. For example, when the number of the printed sheets S from the previous replacement to the present time is recorded as the usage data, the controller 51 clears the number of printed sheets S to zero. For another example, if the percentage of the number of sheets S to be printed further with respect to the recommended number for replacement of the consumable item is recorded as the usage data, the controller 51 sets the percentage to 100. In this context, 100% is the percentage when the number of sheets S having been printed is zero, whereas 0% is the percentage when the number of sheets S having been printed reaches the recommended number.

Thereafter, in S46, in accordance with the usage data being reset, the controller 51 controls the user I/F 54 to display an accepting screen. For example, the user I/F 54 may display an accepting screen 186 as shown in FIG. 11C. The accepting screen 186, as shown in FIG. 11C, informs the user that the usage data is reset. Thereafter, the controller 51 returns to S1 (see FIG. 5) and controls the user I/F 54 to display the standby screen 161.

Next, a printing process to be executed in parallel to the main process (FIG. 5) and the error-condition alerting process (FIGS. 7-8, 10) will be described with reference to FIG. 12. FIG. 12 is a flowchart to illustrate a flow of steps in the printing process to be executed by the controller 51 in the printer 1. The printing process may be executed when the printer 1 receives image data through the network I/F 55 from a terminal device, e.g., PC, connected to the same network, or receives facsimile transmission through a telephone network, or generate image data by reading an image on a sheet with the copier function to print an image based on the image data received, converted, or generated.

First, in S51, if the controller 51 receives a print command, including image data composing an image to be printed, transmitted from a terminal, e.g., a PC, connected to the same network through the network I/F 55, the controller 51 stores the received print command in the memory 52 as a print job. If the controller 51 receives a print command from a facsimile machine through a telephone line, the controller 51 stores image data converted from the received electric signals in the memory 52 as a print job. If the controller 51 reads an image on a sheet with the copier function, the controller 51 stores image data generated by the copier function in the memory 52 as a print job. Optionally, the print job may not necessarily be stored in the memory 52 but may be stored in a RAM or NVRAM provided to the controller 51. Moreover, the controller 51 may store the print jobs in different locations depending on the types of the received print jobs.

In S52, the controller 51 determines whether the error-condition flag is on, and/or the operations of the cooperative members that are operable for printing images in conjunction with the fuser 9 are stopped in the after absence-detection process (FIG. 7). The error-condition flag indicates whether or not the fuser 9 is attached to the printer 1. In particular, the error-condition flag on means that the fuser 9 is not attached to the printer 1.

If the controller 51 determines that the error-condition flag is on and/or the operations of the cooperative members that are operable for printing images in conjunction with the fuser 9 are stopped in the after absence-detection process (FIG. 7) (S52: YES), the controller 51 stands by without printing the image.

On the other hand, if the error-condition flag is off, that is, if the fuser 9 is attached to the printer 1, and the operations of the cooperative members that are operable for printing images in conjunction with the fuser 9 are not stopped in the after absence-detection process (FIG. 7) (S52: NO), the controller 51 executes the currently received print job and print job(s) having been received earlier and stored in the memory 52 that are not yet executed (S53).

As such, in the printer 1 of the present embodiment, when the fuser 9 is detached from the printer 1, operations of the cooperative members are stopped, and while the operations of the cooperative members are stopped, image printing on the sheet S may not be executed. However, the printer 1 may continuously operate to receive image data using the printer function and the facsimile function and to generate image data using the copier function and store the received or generated image data in the memory 52 without being interrupted by the suspension of the cooperative members. Once the printer 1 is loaded with the fuser 9, and the operations of the cooperative members are resumed, the printer 1 is enabled to execute the print jobs, i.e., print the images on the sheets S based on the image data having been stored. Therefore, suspension of the image printing for a long time due to the replacement of the fuser 9 may be prevented.

As described above, in the printer 1 according to the present embodiment, the controller 51 is configured to update the usage data, which is stored in the memory 52 according to the usage of the fuser 9 and indicates the usage degree of the fuser 9. After the fuser-detection switch 56 detects the fuser 9 not being attached to the main body 2 of the printer 1 (S3), in response to the fuser-detection switch 56 detecting the fuser 9 being attached to the main body 2 of the printer 1 (S13), the controller 51 is configured to control the user I/F 54 to display the query screens concerning replacement of the fuser 9 (S25, S27), and in response to a replying operation to the query screens by the user, update the usage data with the content concerning the replacing new fuser 9, of which attachment to the main body 2 is being detected currently (S29). Therefore, when the user replaces the fuser 9 with another, the printer 1 may detect the replacement and display the query screens in the user I/F 54, thereby reducing the operational burden on the user and enabling the usage data to be reliably updated to the contents reflecting the condition after the replacement.

Moreover, in a case where the replying operation by the user is an operation satisfying an updating condition for updating the usage data, the controller 51 is configured to update the usage data with the content concerning the replacing new fuser 9, but in a case where the replying operation by the user is an operation not satisfying the updating condition, the controller 51 is configured not update the usage data. The user may select not to update the usage data with the operation through the query screens. For example, in a case where the fuser 9 having been used is detached from the printer 1 in some reason and attached back to the printer 1, with the selection of not updating the usage data, the usage data may be prevented from being updated unnecessarily.

Moreover, the controller 51 is configured to, after receiving the replying operation to the query screens from the user, control the user I/F 54 to display the standby screen 161 (S1), which includes the consumable-item icon 165. The consumable-item icon 165 is the option to instruct the user I/F 54 to display the updating screen, which is operable for updating the usage data. In response to receiving an operation to select the consumable-item icon 165 in the standby screen 161, the controller 51 is configured to control the user I/F 54 to display the updating screen 181 (S41), and based on an operation by the user to the updating screen 181, update the usage data with the content concerning the replacing new fuser 9 (S45). Therefore, when the controller 51 detects the fuser 9 being attached to the printer 1, the controller 51 may control the user I/F 54 to display the query screens to the user, and if the user does not select updating of the usage data at that time, the usage data may be updated later through the standby screen 161. For example, in a case where the fuser 9 is replaced with another while the printer 1 is powered off, the query screens may not be displayed at the time when the new fuser 9 is attached to the printer 1. However, with the standby screen 161 being displayed when the printer 1 is powered, the usage data may be updated.

Moreover, in response to the fuser-detection switch 56 detecting the fuser 9 not being attached to the main body 2 of the printer 1, the controller 51 is configured to control the cooperative members, which are operable for forming the image on the sheet S in conjunction with the fuser 9, to stop operating (S12), in the state where the cooperative members stop operating, and in the case where the fuser-detection switch 56 detects the fuser 9 being attached to the main body 2 of the printer 1, and under the condition where the predetermined length of time elapses since the fuser-detection switch 56 detecting the fuser 9 being attached, control the cooperative member to resume operating (S16). The period in which the query screens are displayed and the period in which the cooperative members stop operating overlap at least partly. Therefore, during a sequence that the user attaches the fuser 9 to the printer 1, withdraws his/her hand from the fuser 9, and moves the hand to operate the touch panel in the user I/F 54, the operations of the cooperative members that may operate in conjunction with the fuser 9 may be stopped. As a result, safety of the user who replaces the fuser 9 may be ensured.

While the invention has been described in conjunction with an example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

For example, in the main process shown in FIG. 5, the after absence-detection process (S4) may not necessarily be executed in response to the detection of absence of the fuser 9 but may be executed in response to detection of absence of a consumable item other than the fuser 9. For example, the after absence-detection process may be conducted in response to detachment of the conveyer belt 83 from the printer 1 or in response to detachment of the PF kit MP, including the separation pad 42 and the pickup feed roller 43, from the printer 1.

For another example, the replaceable consumable items may not necessarily be limited to the fuser 9, the conveyer belt 83, or the PF kit MP, but other consumable items may cause the controller 51 to execute the main process (FIG. 5) and the error-condition alerting process (FIGS. 7-8 and 10).

For another example, the period, in which the query screens are displayed, and the period, in which the operations of the cooperative members are stopped in the after absence-detection process (FIG. 7), overlap with each other partly; however, those periods may overlap entirely. In other words, the operations of the cooperative members may be stopped while the query screens, i.e., the replacement confirmation screen 172 and the reset confirmation screen 175, are displayed.

For another example, the image forming apparatus in the present disclosure may not necessarily be limited to the printer 1 with the printing function, the facsimile communication function, the copier function, and the scanner function, i.e., a multifunction peripheral machine, but may be provided as, for example, a printer with the printing function alone.

What is claimed is:

1. An image forming apparatus, comprising:
a fuser configured to fix an image formed in toner on a sheet thereon, the fuser being attached to a body of the image forming apparatus and being replaceable;
a detection sensor;
a user interface;
a memory; and
a controller configured to:
update usage data stored in the memory according to usage of the fuser, the usage data indicating a usage degree of the fuser,
after the detection sensor detects the fuser not being attached to the body of the image forming apparatus, in response to the detection sensor detecting the fuser being attached to the body of the image forming apparatus, control the user interface to display a query screen concerning replacement of the fuser, and
in response to a replying operation to the query screen by a user, update the usage data with content concerning a replacing new fuser, of which attachment to the body is being detected currently.

2. The image forming apparatus according to claim 1, wherein the controller is configured to:
in a case where the replying operation by the user is an operation satisfying an updating condition for updating the usage data, update the usage data with the content concerning the replacing new fuser; and
in a case where the replying operation by the user is an operation not satisfying the updating condition, not update the usage data.

3. The image forming apparatus according to claim 2, wherein the operation satisfying the updating condition includes an operation for expressing the fuser is replaced with the replacing new fuser.

4. The image forming apparatus according to claim 3, wherein
the query screen includes an option to express that the fuser is replaced with the replacing new fuser, and
the operation satisfying the updating condition for updating the usage data includes an operation to select the option.

5. The image forming apparatus according to claim 2, wherein the operation satisfying the updating condition for updating the usage data includes an operation to instruct the controller to update the usage data with the content concerning the replacing new fuser.

6. The image forming apparatus according to claim 5, wherein
the query screen includes an option to instruct the controller to update the usage data with the content concerning the replacing new fuser, and
the operation satisfying the updating condition for updating the usage data includes an operation to select the option.

7. The image forming apparatus according to claim 2, wherein
the query screen includes an option to express that the fuser is replaced with the replacing new fuser and an option to instruct the controller to update the usage data with the content concerning the replacing new fuser, and
the operation satisfying the updating condition for updating the usage data includes an operation to select both of the options.

8. The image forming apparatus according to claim 1, further comprising a cover configured to be opened and closed by the user for replacing the fuser,
wherein the controller is configured to:
in response to the detection sensor detecting the fuser not being attached to the body of the image forming apparatus, control cooperative members to stop operating, the cooperative members being operable for forming the image on the sheet in conjunction with the fuser, and
in a state where the cooperative members stop operating, in a case where the detection sensor detects the fuser being attached to the body of the image forming apparatus, and under a condition where a predetermined length of time elapses since the detection sensor detecting the fuser being attached, control the cooperative member to resume operating; and
wherein a period in which the query screen is displayed and a period in which the cooperative members stop operating overlap at least partly.

9. The image forming apparatus according to claim 8, further comprising a communication interface for receiving image data therethrough,
wherein the controller is configured to:
print the image composed of the image data received through the communication interface on the sheet,
receive the image data continuously even in the period in which the cooperative members stop operating,
store the image data received in the period in which the cooperative members stop operating in the memory, and
print the image composed of the image data stored in the memory on the sheet after the cooperative members resume operating.

10. The image forming apparatus according to claim 8, wherein the controller is configured to:
read an image appearing on a sheet, generate image data composing the image having been read, and print the image composed of the generated image data on another sheet,
generate the image data continuously even in the period in which the cooperative members stop operating,
store the image data generated in the period in which the cooperative members stop operating in the memory, and
print the image composed of the image data stored in the memory on the another sheet after the cooperative members resume operating.

11. An image forming apparatus, comprising:
a fuser configured to fix an image formed in toner on a sheet thereon, the fuser being attached to a body of the image forming apparatus and being replaceable;
a detection sensor;
a user interface;
a memory; and
a controller configured to:
update usage data stored in the memory according to usage of the fuser, the usage data indicating a usage degree of the fuser,
after the detection sensor detects the fuser not being attached to the body of the image forming apparatus, in response to the detection sensor detecting the fuser being attached to the body of the image forming apparatus, control the user interface to display a query screen concerning replacement of the fuser,
after receiving a replying operation to the query screen from a user, control the user interface to display a standby screen, the standby screen including an option to instruct the user interface to display an updating screen, the updating screen being operable for updating the usage data,
in response to receiving an operation to select the option to instruct the user interface to display the updating screen through the standby screen, control the user interface to display the updating screen, and
based on an operation by the user to the updating screen, update the usage data with content concerning a replacing new fuser, of which attachment to the body is being detected currently.

12. The image forming apparatus according to claim 11, wherein the updating screen includes an object indicating the usage degree of the fuser.

13. The image forming apparatus according to claim 11, further comprising a sheet conveyer configured to convey the sheet, the sheet conveyer being attached to the body of the image forming apparatus and being replaceable,
wherein the usage data includes data indicating a usage degree of the sheet conveyer, the usage degree of the sheet conveyer being updated according to usage of the sheet conveyer, and
wherein the controller is configured to update the usage data with content concerning the sheet conveyer being a replacing new sheet conveyer based on the operation by the user to the updating screen.

14. The image forming apparatus according to claim 11, further comprising a cover configured to be opened and closed by the user for replacing the fuser,
wherein the controller is configured to:
in response to the detection sensor detecting the fuser not being attached to the body of the image forming apparatus, control cooperative members to stop operating, the cooperative members being operable for forming the image on the sheet in conjunction with the fuser, and
in a state where the cooperative members stop operating, in a case where the detection sensor detects the fuser being attached to the body of the image forming apparatus, and under a condition where a predetermined length of time elapses since the detection sensor detecting the fuser being attached, control the cooperative member to resume operating; and
wherein a period in which the query screen is displayed and a period in which the cooperative members stop operating overlap at least partly.

15. The image forming apparatus according to claim 14, further comprising a communication interface for receiving image data therethrough,
wherein the controller is configured to:
print the image composed of the image data received through the communication interface on the sheet,
receive the image data continuously even in the period in which the cooperative members stop operating,
store the image data received in the period in which the cooperative members stop operating in the memory, and
print the image composed of the image data stored in the memory on the sheet after the cooperative members resume operating.

16. The image forming apparatus according to claim 14, wherein the controller is configured to:
read an image appearing on a sheet, generate image data composing the image having been read, and print the image composed of the generated image data on another sheet,
generate the image data continuously even in the period in which the cooperative members stop operating,
store the image data generated in the period in which the cooperative members stop operating in the memory, and
print the image composed of the image data stored in the memory on the another sheet after the cooperative members resume operating.

17. An image forming apparatus, comprising:
a fuser configured to fix an image formed in toner on a sheet thereon, the fuser being attached to a body of the image forming apparatus and being replaceable;
a detection sensor;
a user interface;
a memory; and
a controller configured to:
update usage data stored in the memory according to usage of the fuser, the usage data indicating a usage degree of the fuser,
in a case where a predetermined condition is satisfied, control the user interface to display a standby screen, the standby screen including an option to instruct the user interface to display an updating screen, the updating screen being operable for updating the usage data,
in response to receiving an operation to select the option instructing the user interface to display the updating screen through the standby screen, control the user interface to display the updating screen, and
based on an operation by the user to the updating screen, update the usage data with content concerning a replacing new fuser, of which attachment to the body is being detected currently.

18. The image forming apparatus according to claim 17, wherein the updating screen includes an object indicating the usage degree of the fuser.

19. The image forming apparatus according to claim 17, further comprising a sheet conveyer configured to convey the sheet, the sheet conveyer being attached to the body of the image forming apparatus and being replaceable,
wherein the usage data includes data indicating a usage degree of the sheet conveyer, the usage degree of the sheet conveyer being updated according to usage of the sheet conveyer, and
wherein the controller is configured to update the usage data with content concerning the sheet conveyer being a replacing new sheet conveyer based on the operation by the user to the updating screen.

20. The image forming apparatus according to claim 17, further comprising a cover configured to be opened and closed by the user for replacing the fuser,
wherein the controller is configured to:
in response to the detection sensor detecting the fuser not being attached to the body of the image forming apparatus, control cooperative members to stop operating, the cooperative members being operable for forming the image on the sheet in conjunction with the fuser, and
in a state where the cooperative members stop operating, in a case where the detection sensor detects the fuser being attached to the body of the image forming apparatus, and under a condition where a predetermined length of time elapses since the detection sensor detecting the fuser being attached, control the cooperative member to resume operating; and
wherein a period in which the query screen is displayed and a period in which the cooperative members stop operating overlap at least partly.

21. The image forming apparatus according to claim 20, further comprising a communication interface for receiving image data therethrough,
wherein the controller is configured to:
print the image composed of the image data received through the communication interface on the sheet,
receive the image data continuously even in the period in which the cooperative members stop operating,
store the image data received in the period in which the cooperative members stop operating in the memory, and
print the image composed of the image data stored in the memory on the sheet after the cooperative members resume operating.

22. The image forming apparatus according to claim 20, wherein the controller is configured to:
read an image appearing on a sheet, generate image data composing the image having been read, and print the image composed of the generated image data on another sheet,
generate the image data continuously even in the period in which the cooperative members stop operating,
store the image data generated in the period in which the cooperative members stop operating in the memory, and
print the image composed of the image data stored in the memory on the another sheet after the cooperative members resume operating.
